(19) United States
(12) Patent Application Publication
(10) Pub. No.: US 2026/0266253 A1
(43) Pub. Date: Sep. 10, 2026

(54) IDLE STOP CONTROL METHOD AND DEVICE FOR VEHICLE WITH INTERNAL COMBUSTION ENGINE

(71) Applicant: NISSAN MOTOR CO., LTD., Yokohama-shi (JP)

(72) Inventors: Rei NAKAGAWA, Kanagawa (JP); Eiki HIRAKAWA, Kanagawa (JP); Kouji NAKAYA, Kanagawa (JP); Katsuhiro DOI, Kanagawa (JP)

(73) Assignee: NISSAN MOTOR CO., LTD., Yokohama-shi (JP)

(21) Appl. No.: 19/561,227

(22) Filed: Mar. 9, 2026

(30) Foreign Application Priority Data
Mar. 10, 2025 (JP) 2025-037116

(51) Int. Cl. F02N 11/08; F01L 13/00; F02D 41/04; F02D 41/06; F02D 41/30

(52) U.S. Cl. CPC F02N 11/0833; F01L 13/00; F02D 41/042; F02D 41/065; F02D 41/30; F02D 2200/101; F02D 2200/50; F02N 2200/022

(57) ABSTRACT

For a vehicle including an internal combustion engine and an automatic transmission, an idle stop control device is presented. A controller is configured to: when the vehicle is at a standstill, perform an idle stop process of stopping combustion of the internal combustion engine with the automatic transmission in a drive range; and implement the idle stop process by: in response to a condition that a predetermined idle stop condition is satisfied after the vehicle has come to a stop, controlling the internal combustion engine by setting a target idle speed of the internal combustion engine to a preset stop-time intermediate idle speed setpoint that is lower than a preset normal idle speed setpoint; and in response to a condition that an actual speed of the internal combustion engine has reached the stop-time intermediate idle speed setpoint, stopping fuel supply to the internal combustion engine.

### BACKGROUND

The present disclosure relates to an idle stop control method and an idle stop control device for a vehicle including an internal combustion engine and an automatic transmission.

When a vehicle is stopped and an internal combustion engine is automatically stopped as an idle stop, a creep force acting on a vehicle body via an automatic transmission suddenly changes, vibrating the vehicle body and causing passengers to feel uncomfortable.

In order to solve such a problem, Japanese patent application publication No. 2002-285882 (JP 2002-285882 A) discloses a technique that, even after fuel supply to an internal combustion engine is stopped and combustion of the internal combustion engine is thereby stopped, rotation of a crankshaft is maintained by a driving torque of a motor-generator linked to the crankshaft, and lowered in speed from a normal idle speed setpoint down to 400 rpm, and thereafter stopped.

### SUMMARY

In the technique of JP 2002-285882 A, in which the engine speed is controlled by driving the motor-generator after fuel supply is stopped, the motor-generator is required to be a relatively expensive one capable of controlling the engine speed. Furthermore, each idle stop causes electric power consumed by the motor-generator. This adversely affects improvement in fuel economy which is produced by idle stopping.

According to one aspect of the present disclosure, an idle stop control method for a vehicle including an internal combustion engine and an automatic transmission, the idle stop control method includes: when the vehicle is at a standstill, performing an idle stop process of stopping combustion of the internal combustion engine with the automatic transmission in a drive range; and implementing the idle stop process by: in response to a condition that a predetermined idle stop condition is satisfied after the vehicle has come to a stop, controlling the internal combustion engine by setting a target idle speed of the internal combustion engine to a preset stop-time intermediate idle speed setpoint that is lower than a preset normal idle speed setpoint; and in response to a condition that an actual speed of the internal combustion engine has reached the stop-time intermediate idle speed setpoint, stopping fuel supply to the internal combustion engine.

According to another aspect of the present disclosure, an idle stop control device for a vehicle including an internal combustion engine and an automatic transmission, the idle stop control device includes a controller configured to: when the vehicle is at a standstill, perform an idle stop process of stopping combustion of the internal combustion engine with the automatic transmission in a drive range; and implement the idle stop process by: in response to a condition that a predetermined idle stop condition is satisfied after the vehicle has come to a stop, controlling the internal combustion engine by setting a target idle speed of the internal combustion engine to a preset stop-time intermediate idle speed setpoint that is lower than a preset normal idle speed setpoint; and in response to a condition that an actual speed of the internal combustion engine has reached the stop-time intermediate idle speed setpoint, stopping fuel supply to the internal combustion engine.

According to a further aspect of the present disclosure, an idle stop control device for a vehicle including an internal combustion engine and an automatic transmission, the idle stop control device includes: means for, when the vehicle is at a standstill, performing an idle stop process of stopping combustion of the internal combustion engine with the automatic transmission in a drive range; and means for implementing the idle stop process by: in response to a condition that a predetermined idle stop condition is satisfied after the vehicle has come to a stop, controlling the internal combustion engine by setting a target idle speed of the internal combustion engine to a preset stop-time intermediate idle speed setpoint that is lower than a preset normal idle speed setpoint; and in response to a condition that an actual speed of the internal combustion engine has reached the stop-time intermediate idle speed setpoint, stopping fuel supply to the internal combustion engine.

### BRIEF DESCRIPTION OF THE DRAWINGS

FIG. 1 is a schematic diagram showing a vehicle system including an idle stop control device according to an embodiment of the present disclosure.

FIG. 2 is a flowchart showing a process of idle stop control according to the present embodiment.

FIG. 3 is a block diagram showing switching of target engine speed for idling.

FIG. 4 is a block diagram showing switching of target alternator generated voltage.

FIGS. 5A-5G are time charts showing an example of behavior of the idle stop control according to the present embodiment.

FIG. 6 is a time chart showing detailed changes in engine speed during the idle stop control.

### DETAILED DESCRIPTION

According to the present embodiment, it is possible to achieve a soft change in creep force during idle stop, since combustion operation of the internal combustion engine is stopped after the engine speed drops to the stop-time intermediate idle speed setpoint.

Furthermore, achievement of a soft change in creep force during idle stop can be accomplished without using any external driving force or external energy from a motor-generator or the like.

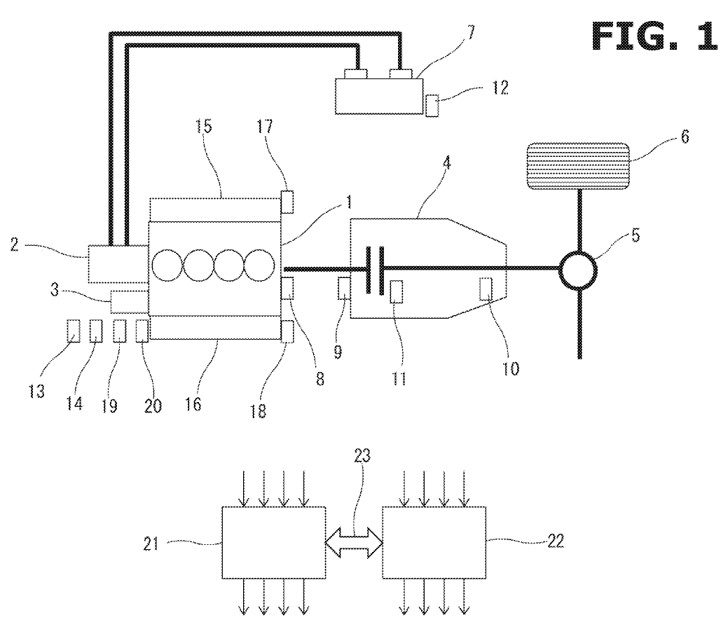

FIG. 1 schematically shows a vehicle system including an idle stop control device according to an embodiment of the present disclosure. The vehicle system includes a vehicle that is a rear-wheel drive vehicle in this example. The vehicle includes an internal combustion engine 1 and a transmission 4 connected to the internal combustion engine 1. The transmission 4 output a torque to drive driving wheels 6 via a final drive unit 5. The transmission 4 is a stepped automatic transmission. The automatic transmission 4 includes a torque converter and a stepped transmission mechanism. The stepped transmission mechanism includes a planetary gear mechanism and multiple friction engagement elements (clutches and/or brakes). The automatic transmission 4 includes an auxiliary oil pump 11 for use during idle stop. The transmission mechanism and the auxiliary oil pump 11 of the automatic transmission 4 are controlled by an automatic transmission controller 22. The automatic transmission 4 is equipped with multiple sensors, wherein the sensors include an input speed sensor 9 and an output speed sensor 10. The sensors output sensing signals to the automatic transmission controller 22. The automatic transmission controller 22 also receives input of sensing signals from other sensors, such as an accelerator position signal.

In this example, the internal combustion engine 1 is a gasoline engine, or a four-stroke, spark-ignition internal combustion engine. The internal combustion engine 1 is controlled by an engine controller 21. The automatic transmission controller 22 and the engine controller 21 are connected to each other via an on-board network 23 (e.g., CAN communication) and configured to transmit and receive signals as required. The engine controller 21 receives input of sensing signals from various sensors directly or via other controllers. The sensors include: a crank angle sensor 8 for sensing the engine speed; an air flow meter 19 for sensing an intake air quantity corresponding to engine load; a water temperature sensor 13 for sensing the coolant temperature; an atmospheric pressure sensor 14 for sensing the atmospheric pressure; and an air-fuel ratio sensor 20 for sensing the exhaust air-fuel ratio. Based on these sensing signals, the engine controller 21 optimally controls a fuel injection valve in terms of fuel injection quantity and fuel injection timing, and a spark plug in terms of ignition timing, and a throttle valve in terms of throttle opening.

In this example, the internal combustion engine 1 is equipped with an intake-side variable valve timing mechanism 15 and an exhaust-side variable valve timing mechanism 16, each of which is a hydraulic variable valve timing mechanism structured to vary valve timing using hydraulic actuators. Each variable valve timing mechanism is structured to advance and retard a phase of a camshaft with respect to a crankshaft by a rotary hydraulic actuator attached to the camshaft. Control positions of the variable valve timing mechanisms are sensed by intake-side and exhaust-side cam angle sensors 17, 18, respectively. The actuator of the exhaust-side variable valve timing mechanism 16 has an intermediate lock position suitable for engine restarting, and is structured to be held in the intermediate lock position by a lock pin.

The internal combustion engine 1 is also provided with a starter motor 2 for cranking the crankshaft and thereby starting the engine. Power is supplied to the starter motor 2 from a battery 7. The battery 7 is equipped with a battery voltage sensor 12. The internal combustion engine 1 is also provided with several accessories, such as an alternator 3 and an air conditioning compressor not shown. These accessories are driven by an output of the internal combustion engine 1, for example, via a belt transmission mechanism.

The vehicle has an idle stop function to stop combustion operation of the internal combustion engine 1 with the automatic transmission 4 in its drive range position (so-called D range position) when the vehicle temporarily stops at an intersection or the like. Specifically, the engine controller 21 automatically stops the internal combustion engine 1, i.e., performs an idle stop, in response to a condition that a predetermined idle stop condition is satisfied, for example, when waiting at a traffic light at an intersection. On the other hand, in response to a condition that a predetermined idle stop cancellation condition is satisfied during the idle stop, the idle stop is canceled and the internal combustion engine 1 is automatically restarted.

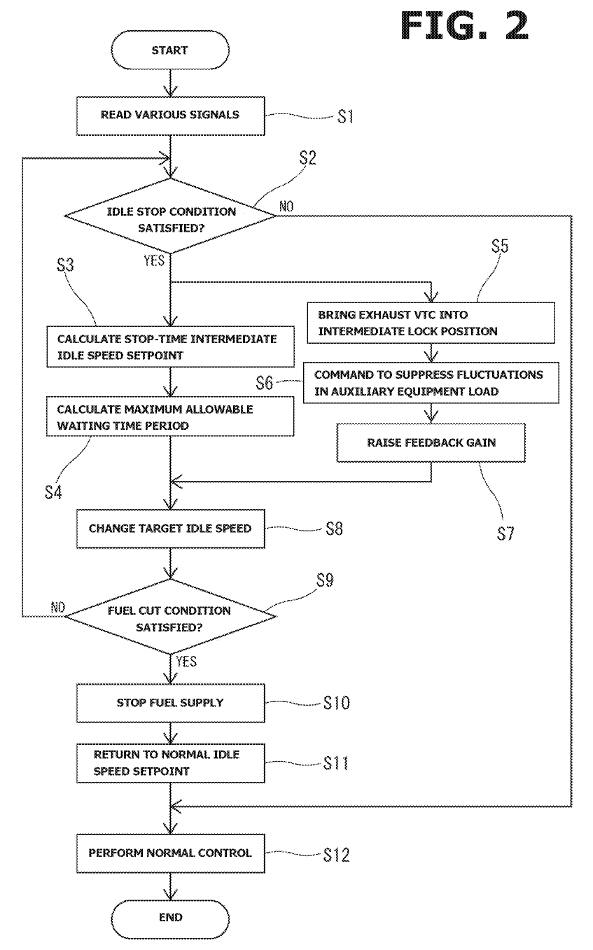

FIG. 2 shows a process of idle stop control according to the present embodiment, which is executed by the engine controller 21. First, at Step S1, the engine controller 21 reads sensing signals from the various sensors described above. Thereafter, at Step SS2, the engine controller 21 determines whether or not the idle stop condition is satisfied. The idle stop condition is an AND condition or logical conjunction of several requirements. The requirements include: a requirement that the vehicle speed is equal to zero; a requirement that the accelerator opening is equal to zero; a requirement that a brake switch is on (i.e., a brake pedal is being depressed); a requirement that the coolant temperature is above a preset threshold temperature; a requirement that the state of charge (SOC) of the battery is above a preset level; and a requirement that no engine start request is received from a vehicle air conditioning system. When all of these requirements are satisfied, the idle stop condition is regarded as satisfied, and a process of idle stop is initiated. When the idle stop condition is not satisfied, the process proceeds from Step S2 to Step S12, where a normal control continues.

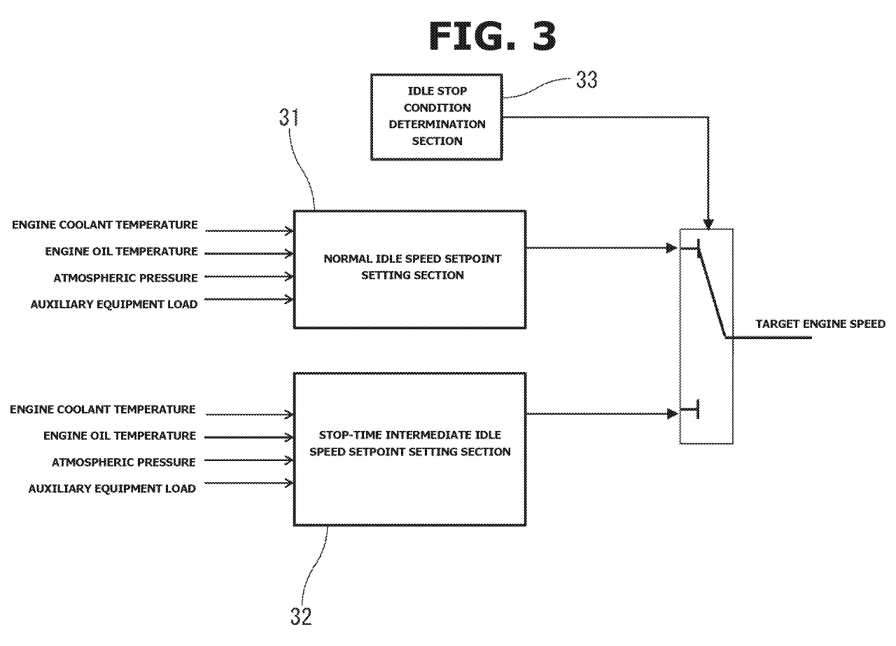

Once the idle stop condition is satisfied, the process proceeds from Step S2 to Step S3. At Step S3, the engine controller 21 calculates a stop-time intermediate idle speed setpoint as a target idle speed of the internal combustion engine 1 for idle stop. The stop-time intermediate idle speed setpoint is lower than a normal idle speed setpoint used during the normal control. The normal idle speed setpoint is set as a point of speed at which idling can be maintained even with fluctuations in auxiliary equipment load and various disturbances. On the other hand, the stop-time intermediate idle speed setpoint is set in vicinity of a limiting speed of the internal combustion engine 1 that allows the internal combustion engine 1 to operate autonomously for a predetermined short period of time. In other words, the stop-time intermediate idle speed setpoint is a lower limit speed at which combustion stability can be maintained. As shown in FIG. 3, this stop-time intermediate idle speed setpoint is set taking into account factors that affect combustion stability, such as the coolant temperature, lubricating oil temperature, atmospheric pressure, and the load of auxiliary equipment such as the alternator 3 and air conditioning compressor.

Subsequent to Step S3, at Step S4, the engine controller 21 calculates a maximum allowable waiting time period from a time instant when the idle stop condition is satisfied to a time instant when fuel supply is stopped, in accordance with the stop-time intermediate idle speed setpoint. The maximum allowable waiting time period is set to prevent the stop of fuel supply from being delayed excessively, for example, when the decrease in engine speed after change in the target idle speed is delayed for some reason. For example, the maximum allowable waiting time period is set by adding a suitable margin to an average time period required from the time instant when the idle stop condition is satisfied to the time instant when fuel supply is stopped (the engine speed has decreased to the stop-time intermediate idle speed setpoint).

In parallel with the flow through Steps S3 and S4, another flow through Steps S5, S6, and S7 is performed. At Step S5, a target control position of the exhaust-side variable valve timing mechanism 16 is set to the intermediate lock position in preparation for the next restart of the engine. With this change in the target control position, the actual control position of the exhaust-side variable valve timing mechanism 16 gradually shifts toward the intermediate lock position.

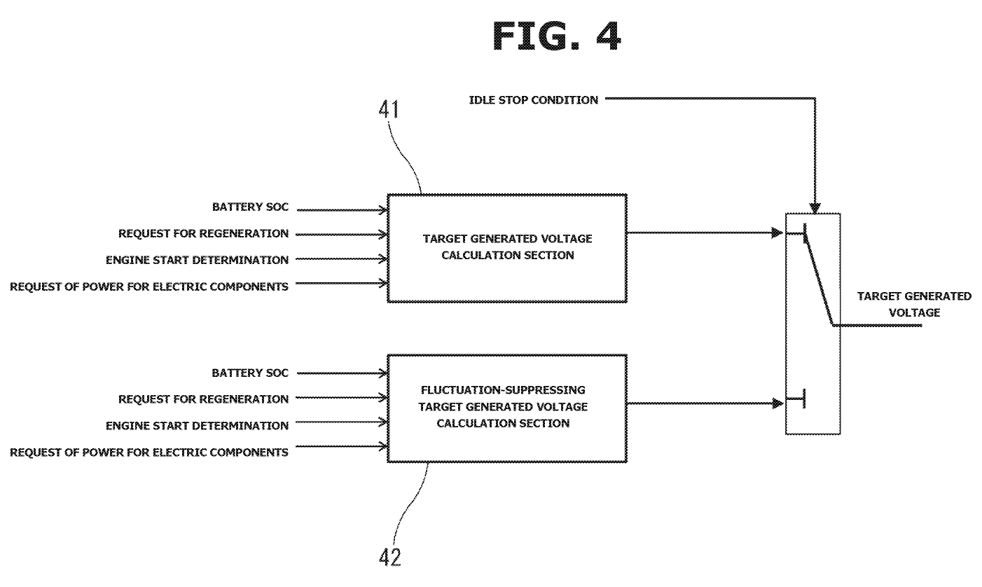

At Step S6, the engine controller 21 starts suppression of fluctuations in the auxiliary equipment load of the alternator 3, air conditioning compressor, etc. For example, as shown in FIG. 4, a target generated voltage of the alternator 3 is normally variably controlled based on the SOC of the battery 7, a request for regeneration, a request for power for various electrical components, determination of start of the internal combustion engine 1, etc. With this change in the target generated voltage of the alternator 3, the drive load of the alternator 3 fluctuates relatively significantly. In contrast, when the idle stop condition is satisfied, the change in the target generated voltage in response to the request based on the SOC of the battery 7 and others is slowed, and response of the generated voltage is softened, thereby reducing fluctuations in the drive load of the alternator 3. Furthermore, the air conditioning compressor is prohibited from being turned on/off or from changed in its capacity. This prevents changes in drive load of the air conditioning compressor.

At Step S7, the engine controller 21 sets a feedback gain for idle speed control higher than in normal control. In this example, the throttle valve opening is controlled in a feedforward manner in accordance with the target idle speed, and then, based on the sensed actual engine speed, the ignition timing is feedback-controlled so as to cause the actual engine speed to follow the target idle speed. In other words, the actual engine speed is maintained at the target idle speed by adjusting the generated torque through advancing or retarding the ignition timing. The feedback gain in this ignition timing feedback control is temporarily set higher than normal. As a result, the actual engine speed is more responsive when the target idle speed changes from the normal idle speed setpoint to the stop-time intermediate idle speed setpoint.

Next, the process proceeds to Step S8. At Step S8, the engine controller 21 changes the target idle speed. Specifically, when the vehicle is stopped, the target idle speed is set to the normal idle speed setpoint. At Step S8, the target idle speed is changed gradually from the normal idle speed setpoint the stop-time intermediate idle speed setpoint. With this change in the target idle speed, the actual engine speed also gradually decreases to the stop-time intermediate idle speed setpoint.

Next, at Step S9, the engine controller 21 determines whether or not the fuel supply stop condition is satisfied. The fuel supply stop condition is an AND condition or logical conjunction of two requirements. The requirements include: a requirement that the actual control position of the exhaust-side variable valve timing mechanism 16 has reached the intermediate lock position; and a requirement that the actual engine speed has reached the stop-time intermediate idle speed setpoint. Furthermore, when a time period elapsed since the idle stop condition is satisfied exceeds the maximum allowable waiting time period, the fuel supply stop condition is regarded as satisfied. Typically, the fuel supply stop condition is satisfied when the actual engine speed reaches the stop-time intermediate idle speed setpoint while the actual control position of the exhaust-side variable valve timing mechanism 16 has already reached the intermediate lock position. Then, the process proceeds to Step S10, where fuel supply is stopped. In a situation where the actual engine speed reaches the stop-time intermediate idle speed setpoint before the exhaust-side variable valve timing mechanism 16 reaches the intermediate lock position, due to slow operation of the exhaust-side variable valve timing mechanism 16, fuel supply is stopped when the actual control position of the exhaust-side variable valve timing mechanism 16 reaches the intermediate lock position. When satisfaction of these conditions is excessively late, fuel supply is stopped based on the maximum allowable waiting time period.

The fuel supply stop at Step S10 results in stopping combustion operation of the internal combustion engine 1.

After the fuel supply stop, the process proceeds to Step S11. At Step S11, the engine controller 21 changes the target idle speed from the stop-time intermediate idle speed setpoint back to the normal idle speed setpoint in preparation for the next restart of the engine.

Thereafter, the process proceeds to Step S12. At Step S12, the engine controller 21 shifts to the normal control by resetting the control of auxiliary equipment load and resetting the feedback gain for idle speed control.

FIG. 3 schematically shows switching of target engine speed for idling. Switching between a normal idle speed setpoint setting section 31 and a stop-time intermediate idle speed setpoint setting section 32 is performed based on an output of an idle stop condition determination section 33. The normal idle speed setpoint setting section 31 sets the normal idle speed setpoint taking into account the coolant temperature, lubricant temperature, atmospheric pressure, and auxiliary equipment load. The stop-time intermediate idle speed setpoint setting section 32 sets the stop-time intermediate idle speed setpoint taking into account the coolant temperature, lubricant temperature, atmospheric pressure, and auxiliary equipment load.

FIG. 4 schematically shows switching of target alternator generated voltage of the alternator 3. Switching between a target generated voltage calculation section 41 and a fluctuation-suppressing target generated voltage calculation section 42 is performed based on the idle stop condition. The target generated voltage calculation section 41 is selected during the normal operation, whereas the fluctuation-suppressing target generated voltage calculation section 42 is selected for fluctuation suppression as requested. The target generated voltage calculation section 41 and the fluctuation-suppressing target generated voltage calculation section 42 both determine the target generated voltage variably based on the SOC of the battery 7 and others. However, the fluctuation-suppressing target generated voltage calculation section 42 limits the change in the target generated voltage so that the target generated voltage changes slowly.

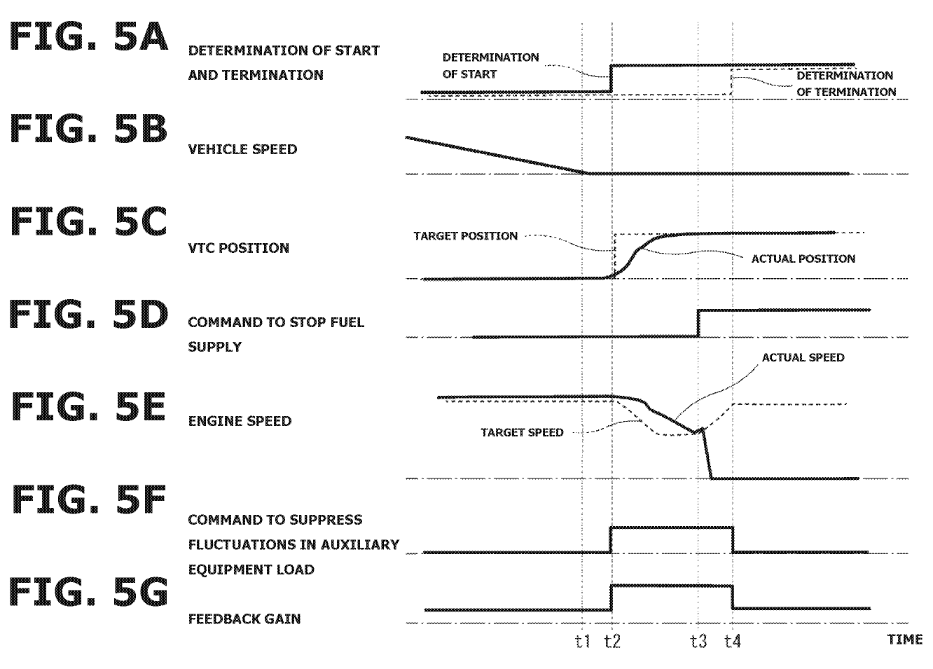

FIGS. 5A-5G show an example of behavior of the idle stop control according to the present embodiment. FIG. 5A shows the on/off status of an engine stop process start flag and the on/off status of an engine stop process end flag. FIG. 5B shows the vehicle speed. FIG. 5C shows the target control position and the actual control position of the exhaust-side variable valve timing mechanism 16. FIG. 5D shows a command to stop the fuel supply. FIG. 5E shows the target engine speed and the actual engine speed. FIG. 5F shows a command to suppress fluctuations in auxiliary equipment load. FIG. 5G shows the feedback gain of idle speed control.

In the example shown in FIGS. 5A-5G, the vehicle decelerates and stops at a time instant t1. Thereafter, at a time instant t2, the idle stop condition is satisfied, and the engine stop process start flag, which indicates a start of the engine stop process, is turned on as shown in FIG. 5A. Then, the target control position of the exhaust-side variable valve timing mechanism 16 is set to the intermediate lock position as shown in FIG. 5C. Since the angular position of the exhaust-side variable valve timing mechanism 16 changes relatively slowly, the actual control position of the exhaust-side variable valve timing mechanism 16 gradually shifts toward the intermediate lock position as shown in FIG. 5C. When the actual control position of the exhaust-side variable valve timing mechanism 16 reaches the intermediate lock position, the lock pin engages in the hydraulic actuator. Simultaneously, the auxiliary load fluctuation suppression command is turned on as shown in FIG. 5F, and the feedback gain of idle speed control is set higher than in normal control as shown in FIG. 5G.

The target idle speed is maintained at the normal idle speed setpoint until the time instant t2 so that the engine speed is controlled in accordance with the normal idle speed setpoint during the time period between the time instants t1 and t2. At the time instant t2 when the idle stop condition is satisfied, the target idle speed starts to be changed gradually from the normal idle speed setpoint to the stop-time intermediate idle speed setpoint. Since the rate of change of the target idle speed is limited, the target idle speed gradually decreases to the stop-time intermediate idle speed setpoint, and is thereafter maintained constant at the stop-time intermediate idle speed setpoint as shown in FIG. 5E.

The actual engine speed is controlled by the idle speed control to decrease with a delay following changes in the target idle speed. At this moment, the feedback gain is set higher than in normal control as shown in FIG. 5G, the decrease in actual engine speed is achieved with relatively good responsiveness. Until the target idle speed reaches the stop-time intermediate idle speed setpoint, the actual engine speed remains relatively higher than the target idle speed.

Thereafter, at a time instant t3, the actual engine speed reaches the stop-time intermediate idle speed setpoint. In response to this condition, fuel supply is stopped as shown in FIG. 5D. Accordingly, the actual engine speed decreases quickly.

In the illustrated example, the exhaust-side variable valve timing mechanism 16 reaches the intermediate lock position before the actual engine speed reaches the stop-time intermediate idle speed setpoint. In general, for a variable valve timing mechanism using a hydraulic actuator, it is difficult to change the control position of the variable valve timing mechanism when rotation of the internal combustion engine 1 is completely stopped. However, since the exhaust-side variable valve timing mechanism 16 shifts to the intermediate lock position and the idle speed decreases to the stop-time intermediate idle speed setpoint simultaneously, it is possible to complete the operation of the exhaust-side variable valve timing mechanism 16 while the engine is rotating.

After the time instant t3 when fuel supply is stopped, the target idle speed is returned to the normal idle speed setpoint in preparation for restarting of the engine. At this moment, the rate of change in the target idle speed is also limited so that the target idle speed gradually increases as shown FIG. 5E. Thereafter, at a time instant t4, the target idle speed reaches the normal idle speed setpoint, and the engine stop processing end determination flag is turned on as shown in FIG. 5A, indicating the end of the engine stop processing sequence. The process is thus completed.

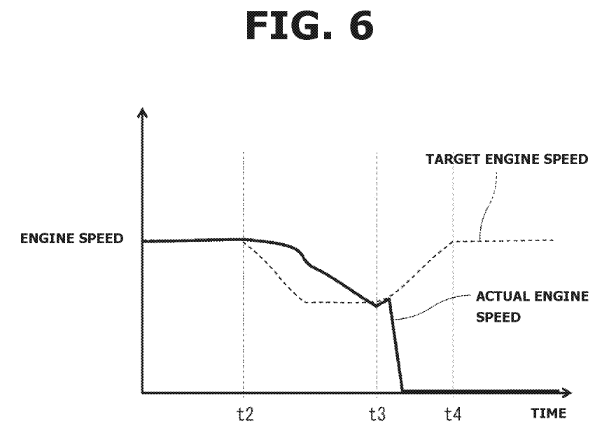

FIG. 6 shows detailed changes in engine speed during the idle stop control.

As described above, during idle stop, the actual engine speed is temporarily reduced to the stop-time intermediate idle speed setpoint, which is lower than the normal idle speed setpoint, and then fuel supply is stopped (i.e., combustion operation is stopped). This prevents sudden changes in creep force acting on the vehicle body.

The control process according to the present embodiment may appear to require a longer time period from the satisfaction of the idle stop condition to the stop of fuel supply. However, in an internal combustion engine equipped with a hydraulic variable valve mechanism, it is required to be on standby for fuel supply stop until the variable valve mechanism reaches a locked position suitable for engine restarting. Therefore, in reality, there is not much difference in the time period required from the satisfaction to the stop of fuel supply.

Furthermore, the feature that the stop-time intermediate idle speed setpoint is set lower than the normal idle speed setpoint but set at a level that allows the internal combustion engine 1 to operate autonomously, serves to allow the engine to smoothly shift to the normal idle speed setpoint and restart without stalling, when the idle stop cancellation condition is satisfied, for example, by releasing the brake pedal, during the time period between the satisfaction of the idle stop condition and the stop of fuel supply.

Furthermore, the feature that the target idle speed is gradually changed and fluctuations in the auxiliary equipment load are suppressed, serves to allow the stop-time intermediate idle speed setpoint to be set lower.

Although the specific embodiment is described above, various modifications are possible. For example, the present disclosure is applicable to the internal combustion engine 1 even without the exhaust-side variable valve timing mechanism 16.

The entire contents of Japanese Patent Application 2025-037116 filed Mar. 10, 2025 are incorporated herein by reference.

Although the invention has been described above by reference to certain embodiments of the invention, the invention is not limited to the embodiments described above. Modifications and variations of the embodiments described above will occur to those skilled in the art in light of the above teachings. The scope of the invention is defined with reference to the following claims.

1. An idle stop control method for a vehicle including an internal combustion engine and an automatic transmission, the idle stop control method comprising:
when the vehicle is at a standstill, performing an idle stop process of stopping combustion of the internal combustion engine with the automatic transmission in a drive range; and
implementing the idle stop process by:
in response to a condition that a predetermined idle stop condition is satisfied after the vehicle has come to a stop, controlling the internal combustion engine by setting a target idle speed of the internal combustion engine to a preset stop-time intermediate idle speed setpoint that is lower than a preset normal idle speed setpoint; and
in response to a condition that an actual speed of the internal combustion engine has reached the stop-time intermediate idle speed setpoint, stopping fuel supply to the internal combustion engine.

2. The idle stop control method as claimed in claim 1, comprising:
setting the stop-time intermediate idle speed setpoint in vicinity of a limiting speed of the internal combustion engine that allows the internal combustion engine to operate autonomously for a predetermined short period of time.

3. The idle stop control method as claimed in claim 1, comprising:
changing the target idle speed gradually from the normal idle speed setpoint to the stop-time intermediate idle speed setpoint.

4. The idle stop control method as claimed in claim 1, comprising:
setting a feedback gain for idle speed control higher than in normal control, during a period of time from the satisfaction of the idle stop condition to the stop of fuel supply.

5. The idle stop control method as claimed in claim 1, comprising:
suppressing fluctuations in auxiliary equipment load during a period of time from the satisfaction of the idle stop condition to the stop of fuel supply.

6. The idle stop control method as claimed in claim 1, wherein the internal combustion engine includes a hydraulic variable valve timing mechanism, the idle stop control method comprising:
in response to the condition that the idle stop condition is satisfied, controlling the hydraulic variable valve timing mechanism by setting a target position of the hydraulic variable valve timing mechanism to a predetermined lock position suitable for restarting; and
in response to a condition that an actual position of the hydraulic variable valve timing mechanism has reached the lock position, permitting the stop of fuel supply.

7. The idle stop control method as claimed in claim 1, comprising:
setting a maximum allowable waiting time period for a period of time from the satisfaction of the idle stop condition to the stop of fuel supply; and
in response to a condition that the maximum allowable waiting time period has elapsed before the actual speed reaches the stop-time intermediate idle speed setpoint, stopping fuel supply to the internal combustion engine.

8. The idle stop control method as claimed in claim 1, comprising:
in response to a condition that rotation of the internal combustion engine has stopped due to the stop of fuel supply, returning the target idle speed to the normal idle speed setpoint.

9. An idle stop control device for a vehicle including an internal combustion engine and an automatic transmission, the idle stop control device comprising a controller configured to:
when the vehicle is at a standstill, perform an idle stop process of stopping combustion of the internal combustion engine with the automatic transmission in a drive range; and
implement the idle stop process by:
in response to a condition that a predetermined idle stop condition is satisfied after the vehicle has come to a stop, controlling the internal combustion engine by setting a target idle speed of the internal combustion engine to a preset stop-time intermediate idle speed setpoint that is lower than a preset normal idle speed setpoint; and
in response to a condition that an actual speed of the internal combustion engine has reached the stop-time intermediate idle speed setpoint, stopping fuel supply to the internal combustion engine.

10. An idle stop control device for a vehicle including an internal combustion engine and an automatic transmission, the idle stop control device comprising:
means for, when the vehicle is at a standstill, performing an idle stop process of stopping combustion of the internal combustion engine with the automatic transmission in a drive range; and
means for implementing the idle stop process by:
in response to a condition that a predetermined idle stop condition is satisfied after the vehicle has come to a stop, controlling the internal combustion engine by setting a target idle speed of the internal combustion engine to a preset stop-time intermediate idle speed setpoint that is lower than a preset normal idle speed setpoint; and
in response to a condition that an actual speed of the internal combustion engine has reached the stop-time intermediate idle speed setpoint, stopping fuel supply to the internal combustion engine.
